(19) United States
(12) Patent Application Publication
(10) Pub. No.: US 2016/0336974 A1
(43) Pub. Date: Nov. 17, 2016

(54) SIGNAL TRANSMISSION DEVICE

(71) Applicants: HONG FU JIN PRECISION INDUSTRY (ShenZhen) CO., LTD, Shenzhen (CN); HON HAI PRECISION INDUSTRY CO., LTD., New Taipei (TW)

(72) Inventors: YANG GAO, Shenzhen (CN); KANG WU, Shenzhen (CN)

(21) Appl. No.: 14/755,447

(22) Filed: Jun. 30, 2015

(30) Foreign Application Priority Data
May 11, 2015 (CN) 201510235029.2

(51) Int. Cl. H04B 1/04

(52) U.S. Cl. CPC H04B 1/0475

(57) ABSTRACT

A signal transmission device includes a signal output module, a signal reception module, and a signal compensation module. The signal output module is configured to output a first signal. The signal compensation module is configured to output different compensation signals, according to attenuations of the first signal received, to compensate the first signal, and output a compensated first signal.

### FIELD

The subject matter herein generally relates to a signal transmission device.

### BACKGROUND

Qualities of signals received by a signal receiver are affected on lengths of a transmission lines, interferences between signals, or differences of signal generators.

### BRIEF DESCRIPTION OF THE DRAWINGS

Implementations of the present technology will now be described, by way of example only, with reference to the attached figures.

FIG. 1 is a block diagram of an example embodiment of a signal transmission device comprising a signal compensation module.

FIG. 2 is a block diagram of the signal compensation module of FIG. 1 of an example embodiment.

FIG. 3 is a circuit diagram of the signal compensation module of FIG. 1 of an another example embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

The present disclosure is described in relation to a signal transmission device 100.

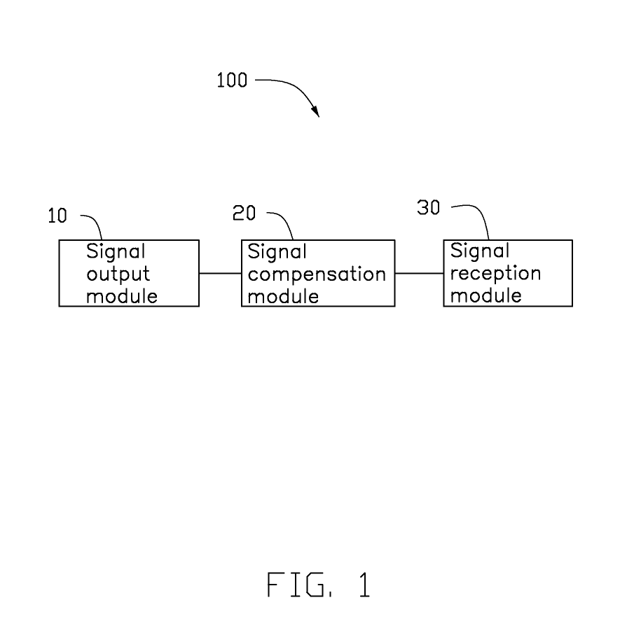

FIG. 1 illustrates an embodiment of the signal transmission device 100. The signal transmission device 100 can comprise a signal output module 10, a signal compensation module 20, and a signal reception module 30.

The signal output module 10 is configured to output a first signal to the signal reception module 30 through the signal compensation module 20. The signal compensation module 20 is configured to output different compensation signals, according to attenuations of the first signal, to compensate the first signal. In at least one embodiment, the signal compensation module 20 is positioned in the signal reception module 30 for avoiding an attenuation of a transmission line between the signal compensation module 20 and the signal reception module 30.

In at least one embodiment, the signal output module 10 is a hard-disk drive. The signal reception module 30 is a platform controller hub (PCH).

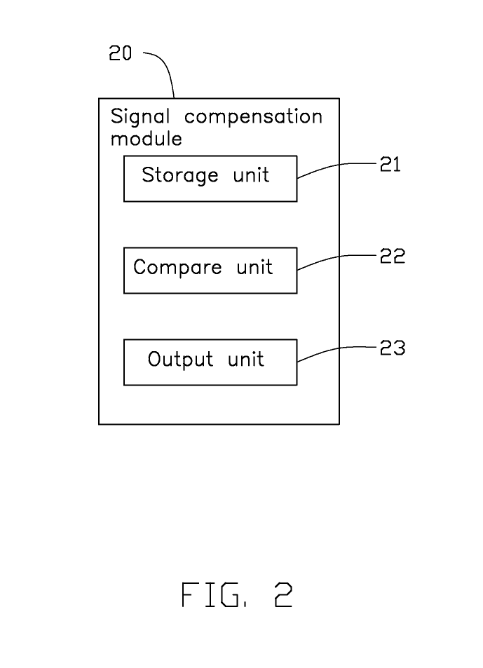

FIG. 2 illustrates an embodiment of the signal compensation module 20. The signal compensation module 20 can comprise a storage unit 21, a compare unit 22, and an output unit 23. A reference value and first to third compensation signals are stored in the storage unit 21. The compare unit 22 is configured to compare the first signal with the reference value and obtain a compare result. The output unit 23 is configured to choose one of the first to third compensation signals to compensate the first signal, according to the compare result, to obtain a compensated first signal, and output the compensated first signal to the signal reception module 30.

When a voltage of the first signal received by the signal compensation module 20 is less than the reference value, that is an attenuation of the first signal is large, the output unit 23 chooses the first compensation signal to compensate the first signal and then output the compensated first signal. When the voltage of the first signal received by the signal compensation module 20 is equal to the reference value, that is an attenuation of the first signal is moderate, the output unit 23 chooses the second compensation signal to compensate the first signal and then output the compensated first signal. When the voltage of the first signal received by the signal compensation module 20 is greater than the reference value, that is an attenuation of the first signal is less, the output unit 23 chooses the third compensation signal to compensate the first signal and then output the compensated first signal.

In at least one embodiment, a value of the first compensation signal is greater than a value of the second compensation signal and the value of the second compensation signal is greater than a value of the third compensation signal. In other embodiments, the values of the first to the third compensation signals and the reference value are set as needed.

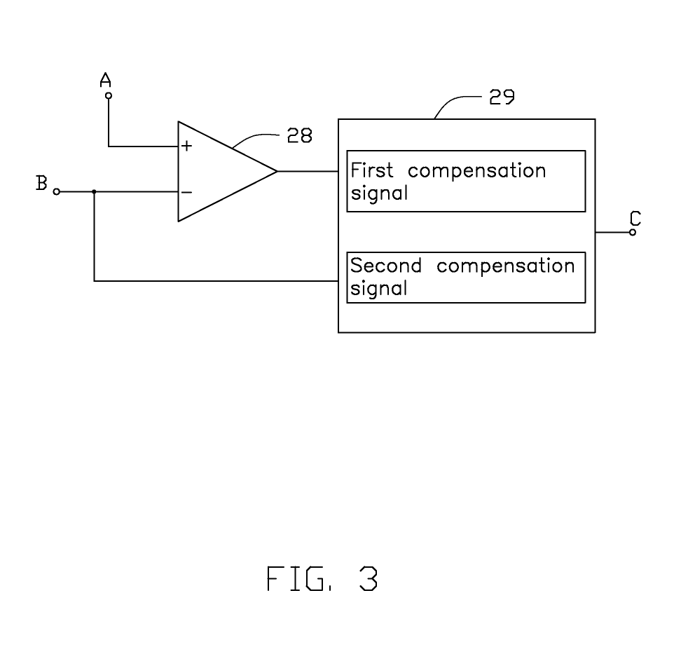

FIG. 3 illustrates another embodiment of the signal compensation module 20. The signal compensation module 20 can comprise a comparator 28 and a processor 29. A first compensation signal and a second compensation signal are preset in the processor 29. A non-inverting input terminal A of the comparator 28 is configured to receive a reference value. An inverting input terminal B of the comparator 28 is configured to receive the first signal. The comparator 28 is configured to compare the first signal with the reference value and output a compare result to the processor 29. A first input pin of the processor 29 is coupled to the output terminal of the comparator 28 to receive the compare result. A second input pin of the processor 29 is coupled to the inverting input terminal B of the comparator 28 to receive the first signal. An output pin C of the processor 29 is configured to output a compensated first signal.

When the output pin of the processor 29 outputs a high level signal, the first signal is less than the reference value, an attenuation of the first signal is large. The processor 29 chooses the first compensation signal to compensate the first signal and then output the compensated first signal. When the output pin of the processor 29 outputs a low level signal, the first signal is greater than the reference value, an attenuation of the first signal is less. The processor 29 chooses the second compensation signal to compensate the first signal and then output the compensated first signal.

The embodiments shown and described above are only examples. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A signal transmission device comprising:
a signal output module configured to output a first signal;
a signal compensation module electrically coupled to the signal outputting module, the signal compensation module configured to receive the first signal and to choose one compensation signal from amongst a plurality of compensation signals, according to attenuations of the first signal, and to compensate the first signal, and output a compensated first signal; and
a signal reception module electrically coupled to the signal compensation module, the signal reception module configured to receive the compensated first signal.

2. The signal transmission device of claim 1, wherein the signal compensation module can comprises a storage unit, a compare unit, and an output unit, the storage unit is configured to store a reference value and at least two compensation signals, the compare unit is configured to compare a voltage of the first signal with the reference value to obtain a compare result, the output unit is configured to choose one of the compensation signals to compensate the first signal, according to the compare result, to obtain the compensated first signal, and output the compensated first signal.

3. The signal transmission device of claim 2, wherein first to third compensation signals are stored in the storage unit, when the voltage the first signal received by the signal compensation module is less than the reference value, the output unit chooses the first compensation signal to compensate the first signal and then output the compensated first signal, when the voltage of the first signal received by the signal compensation module is equal to the reference value, the output unit chooses the second compensation signal to compensate the first signal and then output the compensated first signal, when the voltage of the first signal received by the signal compensation module is greater than the reference value, the output unit chooses the third compensation signal to compensate the first signal and then output the compensated first signal.

4. The signal transmission device of claim 3, wherein a value of the first compensation signal is greater than a value of the second compensation signal and the value of the second compensation signal is greater than a value of the third compensation signal.

5. The signal transmission device of claim 3, wherein values of the first to the third compensation signals and the reference value are set as needed.

6. The signal transmission device of claim 1, wherein the signal compensation module is positioned in the signal reception module.

7. The signal transmission device of claim 1, wherein the signal output module is a hard-disk drive.

8. The signal transmission device of claim 1, wherein the signal reception module is a platform controller hub (PCH).

9. The signal transmission device of claim 1, wherein the signal compensation module comprises a comparator and a processor, a first compensation signal and a second compensation signal are preset in the processor, the comparator is configured to compare a voltage of the first signal with a reference value and output a compare result to the processor, the processor is configured to receive the compare result for choosing one of the compensation signals to compensate the first signal and then output a compensated first signal.

10. The signal transmission device of claim 9, wherein a non-inverting input terminal of the comparator is configured to receive a reference value, an inverting input terminal of the comparator is configured to receive the first signal, a first input pin of the processor is coupled to an output terminal of the comparator to receive the compare result, a second input pin of the processor is coupled to the inverting input terminal of the comparator to receive the first signal, an output pin of the processor is configured to output the compensating first signal.
